(19) United States
(12) Patent Application Publication
(10) Pub. No.: US 2014/0177051 A1
(43) Pub. Date: Jun. 26, 2014

(54) Holographic Display System

(71) Applicants: Elaine Frances Kopko, Fairfax, CA (US); William Leslie Kopko, Jacobus, PA (US)

(72) Inventors: Elaine Frances Kopko, Fairfax, CA (US); William Leslie Kopko, Jacobus, PA (US)

(21) Appl. No.: 13/723,223

(22) Filed: Dec. 21, 2012

(51) Int. Cl. G02B 27/22; G02B 27/24

(52) U.S. Cl. CPC G02B 27/22; G02B 27/24
USPC 359/479; 359/478

(57) ABSTRACT

A holographic display system for producing three-dimensional virtual images that are similar those of a real object seen through a conventional glass window. A basic display element comprises a lens and an image element such as conventional display screen, film, slide, or photograph. For this embodiment, the distance between the image element and the lens is approximately equal to the focal length of the lens. This setup means that different viewing angles correspond to different physical locations on the image. The apparent magnification of the image element increases as the observer moves away from the lens, which simulates the reduction in viewing angle of a real window. Selecting a distance between the lens and display that is less than the focal length of the lens allows for more accurate representation nearby objects. Other embodiments use mirror or diverging lenses. Also a variety of configurations for producing, recording, and transmitting images are described that use single or multiple cameras. While a single display element can produce a useful image, multiple display elements can seamlessly create an image with binocular vision effects and realistic display of objects from multiple viewing angles.

This application claims benefit of Provisional Patent Application No. 61/580,103 filed on Dec. 23, 2011, by the present inventors, which is hereby incorporated by reference.

### BACKGROUND

Attempts to create the illusion of a three-dimensional image date back hundreds of years. The invention of perspective drawing in the Renaissance and later the invention of photography provided ways to create a two-dimensional projection of light reflected from three-dimensional objects. A projection creates the illusion of a three-dimensional object, but it is only realistic if viewed from a single location. Any movement of the observer or even viewing the projection with both eyes may disrupt this illusion.

More recent systems use various approaches to ensure that each eye sees separate images that are from slightly different viewing angles to create the illusion of depth. The earliest systems date back to the nineteenth century with stereoscopes. The stereoscope used a small hole for each eye to view its corresponding image so as to keep correct alignment for producing the illusion of depth.

In a similar way, modern three-dimensional movies use special viewing glasses with polarizing or color filters to provide different images to the eyes. In addition to the inconvenience of glasses, these systems require the observers to keep their eyes nearly level with respect to the screen or else their eyes will not be able to correctly put the images together to create the illusion of depth. Also moving vertically or toward or away from the movie screen does not produce a realistic change in the viewing angles.

Lenticular printing is another system for approximating three-dimensional images. Lenticular printing typically uses an extruded clear plastic cover over a printed surface. The plastic cover has a wavy pattern that forms columns of two-dimensional lens. The image on the printed surface is arranged in vertical strips that line up with the lenses in the plastic. This system can give an illusion of parallax in the horizontal direction, but not in the vertical. It also requires that the viewer's eyes are level with the print for the eyes to align the images properly. Lenticular printing has seen limited use in producing novelty items and some displays.

The only system in the prior art that is currently capable of producing a true three-dimensional image is a hologram. Holograms use a coherent light source, such as a laser, to record interference patterns on an extremely high-resolution film. The interference patterns allow for regeneration of the original three-dimensional image using the same coherent light source.

The resulting hologram produces an effect that is similar to that of viewing a three-dimensional object through a window. Movement of the observer results in an appropriate change in the observed image, which provides the three-dimension illusion.

While holograms can provide a true three-dimensional image, they have many practical problems that severely limit their use. First, a true hologram requires light from a single wave length, which limits the ability to record color images. Second, holograms need laser light in order to create a true three-dimensional image; images that work with conventional light preserve parallax information only in one direction. Third, there is no practical way to create a moving three-dimension image with holograms. Fourth, production of holograms requires extremely stable studio environment since the slightest movement or vibration can destroy the required interference patterns. Fifth, the extremely high resolution to produce a hologram normally requires special film and may require long exposure times.

### SUMMARY OF THE INVENTION

The present invention combines image elements and focusing elements to create a holographic display. The system uses a display element that includes a focusing means and an image means. The image means provides a real, two-dimensional image. The focusing means directs a light ray from a particular spatial location on the surface of the image element to corresponding projection angle. In a basic embodiment the focusing element comprises a lens that is located about one focal length or less from an illuminated surface of the image. In this case, the lens is preferably a Fresnel lens or a convex lens. In one of the projection embodiments the focusing means comprises a projector in combination with curved mirrors. Various embodiments of the system are capable of producing color and moving images real-time. The system has wide range of uses including computer graphics, signage, entertainment, and camouflage.

A comparison between an image of an object on a computer screen and viewing the same object through a glass window shows the fundamental problem in producing a realistic 3-D image. A conventional computer screen produces a variation in light intensity over its two-dimensional surface; any point on the surface of a screen has only one light intensity that is more or less independent of viewing angle. In contrast, any point on the surface of a glass window transmits light that varies in intensity depending on the viewing angle.

A breakthrough in the development of the invention was the recognition that producing light that varies with viewing angle from a particular location is really like running a camera in reverse. A conventional camera when focused at a distant object (“infinity”) uses a lens to focus incoming light from a particular angle to a single point on an imaging surface. For light moving in the opposite direction, a point on the image corresponds to a ray of outgoing light at a particular angle.

### DRAWINGS—FIGURES

FIG. 1 is an example holographic display element viewed head on.

FIG. 2 is an example holographic display element illustrating paths of light viewed from an angle.

FIG. 3 shows the effect of viewing distance for an element.

FIG. 4 shows how the view of a distant three-dimensional object changes with distance from a viewing window.

FIG. 5 shows an array of two-dimensional images.

FIG. 6 shows the array of images as viewed through an array of lenses so as to form a three-dimensional image.

FIG. 7 illustrates an array of images that show the same three-dimensional object viewed from different locations.

FIG. 8 shows a simple embodiment of a holographic display that uses a conventional computer screen to produce an array of images.

FIG. 9 shows a display with multiple layers of two-dimensional images.

FIG. 10 is a holographic display with elements arranged in a cylinder.

FIG. 11 shows how mirrors can be used with a flat screen to produce images for a cylindrical holographic display.

FIG. 12 shows an cylindrical display that is suitable for viewing from the inside.

FIG. 13 is an example holographic display element with a mirror as the focusing means.

FIG. 14 shows holographic display that uses includes a projector.

FIG. 15 illustrates an optical system for recording an array of images using a single camera.

### DESCRIPTION OF THE INVENTION

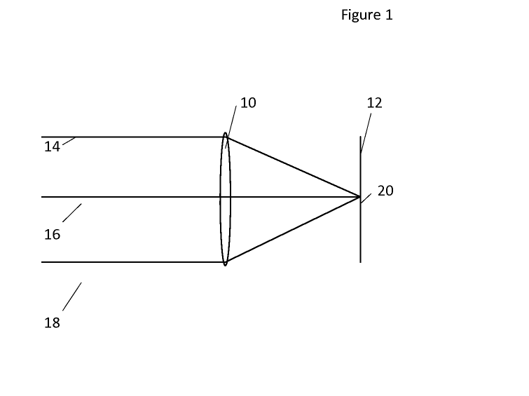

FIG. 1 shows a basic element of the invention that is based on reversing the operation of a camera. A focusing means 10 is located approximately one focal length from an image means 12. The focusing means is preferably a lens with positive focal length. The preferred type of lens is a Fresnel lens, but other alternatives for the focusing means include a convex or biconvex lens or a simple pinhole. In contrast to the plastic covers used in lenticular printing, the focusing means should capable of producing a two-dimensional real image from incoming light. The image means provides a real two-dimensional image that is visible from the lens. The image means may be an illuminated display screen such an LED, LCD, plasma, CRT, or a rear projection screen. Alternatively it may be a printed surface with illumination from ambient light or light source that provides light to the surface. Another alternative for the image means is screen that is illuminated from behind such as found in projection televisions. Yet another alternative is a photographic slide or a transparency similar to those used with overhead projectors with a source of light from behind the image.

A key feature of this configuration is that is light from a point on the image means produces rays of light that approximate those from an actual three-dimensional object. For the case where the imaged object is far away, the focusing means creates approximately parallel rays of light corresponding to a particular location on the image means. For example a point 20, which is located on the surface of the image means produces rays 14, 16, and 18 that are approximately parallel as they exit the focusing means. As shown in the figure, ray 14 leaves near the top of the lens, ray 16 is near the axis of the lens, and ray 18 leaves near the bottom of the lens.

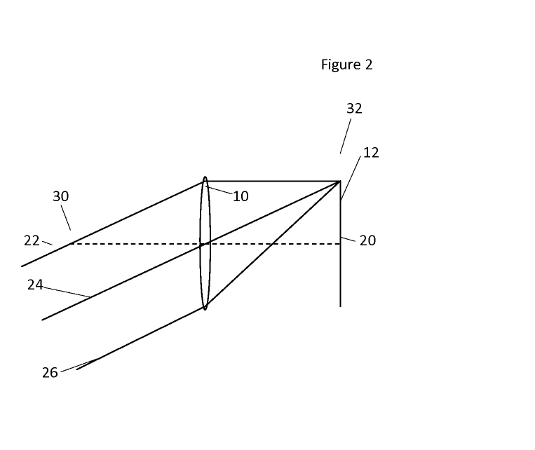

FIG. 2 shows the same element with ray for a point 32 near the top of the image means. A ray of light 22 leaves at a right angle from the point 32 on the image means 12 through the lens 10 and a focal point 30. Point 32 also emits rays of light 24 and 26 that go through the lens 10. These rays are approximately parallel with ray 22 after they exit the lens.

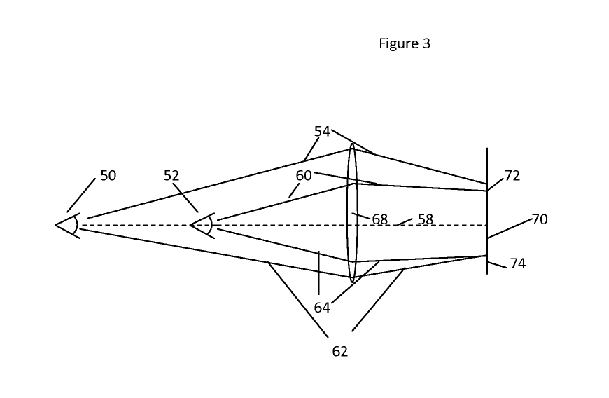

FIG. 3 shows how changing the position of the observer changes the appearance of an image 70 viewed through a lens 58 that is approximately one focal length from the image. A farther observer 50 sees light ray 54 from a higher point 72 and a light ray 62 from a lower point 74 of the image 70. Likewise a closer observer 52 sees light ray 60 from the higher point 72 and a light ray 64 from the lower point 74. The focusing effect of the lens 68 means that the angle between the light rays 54 and 62 going to the farther observer are essentially the same as that for the light rays 60 and 64 going to the closer observer. Since the angles are the same, the image appears to remain the same size to both observers even though the viewing distance is different.

This effect is the essentially the same as viewing a distant object through a window. By distant object we mean that the distance from the viewer to the window is much smaller than the distance from the viewer to the object.

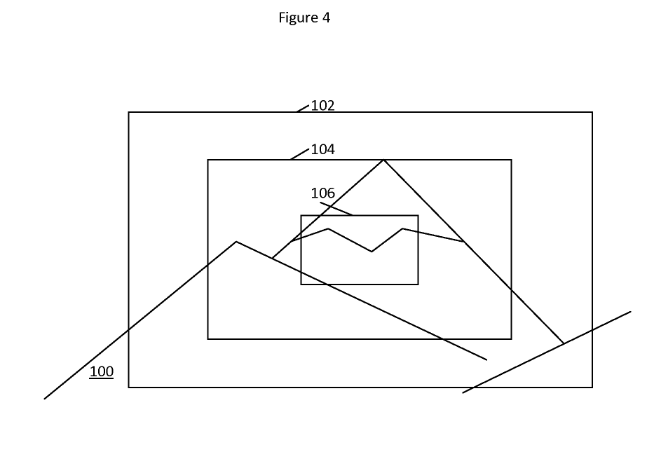

To illustrate the comparison further, FIG. 4 shows how moving closer to a window affects the appearance of a distance object 100. Frame 102 shows the apparent of a window when the observer is close to the window. Frame 104 shows apparent size of the same window when the observer is farther away, and frame 106 shows the apparent window size for an even farther observer. The frame appears smaller due to perspective at the different distances, but the distant object remains the same size since the distance to it is essentially unchanged. The result is that window frame effectively crops the view of the distant object with the amount of cropping depending on the distance from the viewer to the frame.

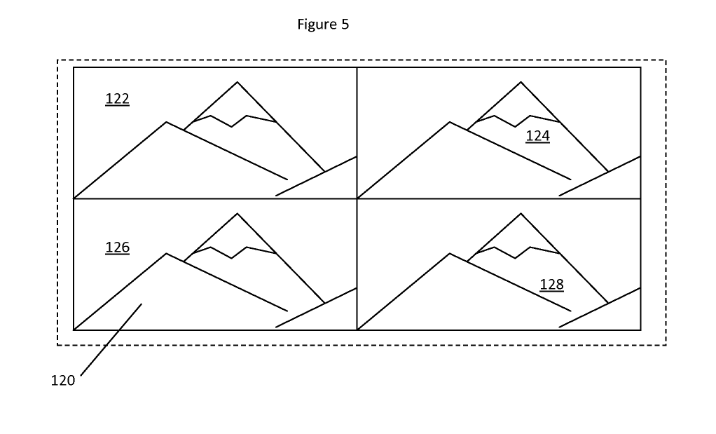

FIG. 5 shows an image array 120 of four images 122, 124, 126, and 128. For this case the images are essentially the same, and represent four views of a distant object.

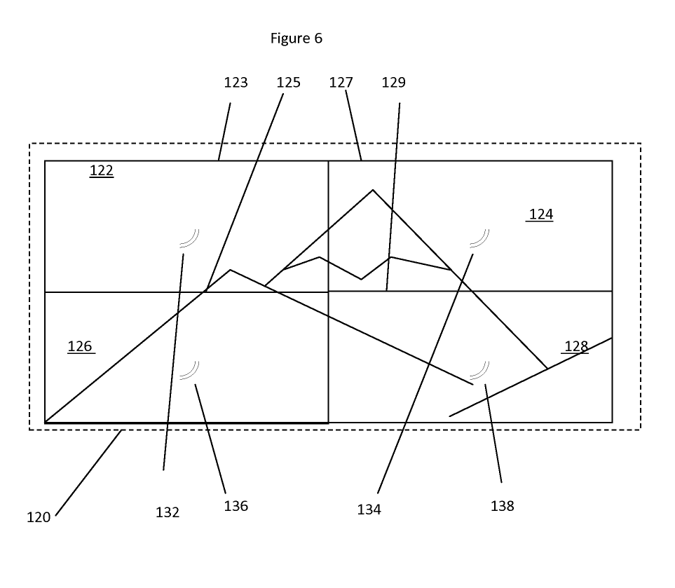

FIG. 6 shows the view of the same image array 120 through an array of four lenses 132, 134, 136, and 138 that are about one focal length from the images. The four corresponding images 122, 124, 126, and 128 merge to form a single three-dimensional image which appears to be of a distant object. Each lens is approximately the same outside dimensions as the corresponding image. The surfaces of the lenses are approximately parallel to the surface of the images, and the center of focus of each lens corresponds to the center of the corresponding image. The lenses are preferably plastic Fresnel lenses of the type used for magnifying glasses and have fine concentric circular grooves around the center of focus that are shown as faint lines for each lens.

The image as shown corresponds to that visible from about two focal lengths in front of the center of the array, which corresponds to the where the corners of the four lenses touch. As described earlier, the visible image will vary with the location of the viewer relative to the display so as to give the illusion of viewing a distant object through a window. For an observer with binocular vision, the visible image is different for each eye and consistent with viewing a distant object through a window.

Optional partitions 123, 125, 127, and 129 extend from the perimeter of each image section to a location near the lens. The partitions prevent viewing of an image section through a lens other than the one located directly in front of the image section. Example materials include construction paper or other opaque or translucent material. The partition material preferably does not have a glossy or mirrored surface finish so as to prevent confusing specular reflection.

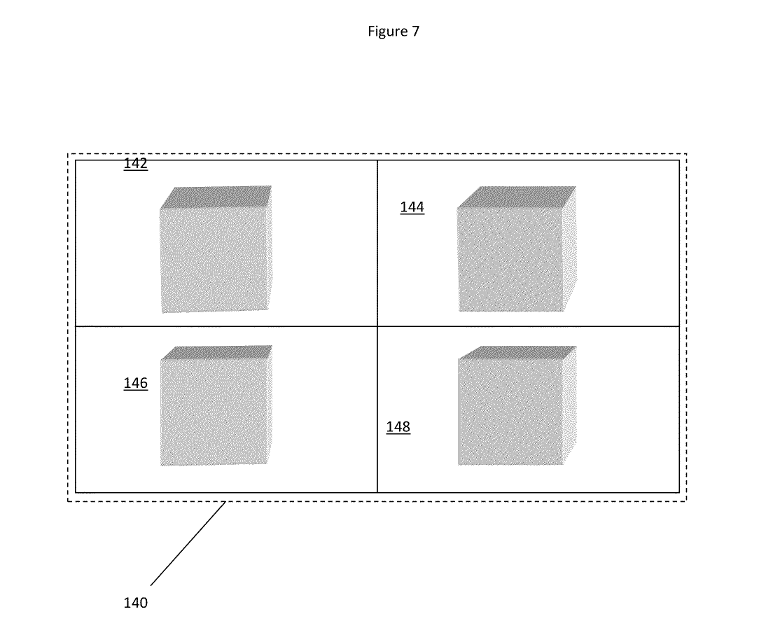

FIG. 7 shows images 140 with four images 142, 144, 146, and 148 that create the illusion of a three-dimensional cube. Each section corresponds to a two-dimensional image that approximates the view of a real object from a location that corresponds to the center of each lens. When viewed through the four lenses described earlier, the four image sections appear to merge to form a single three-dimensional image that changes depending on the exact position of the observer. For an observer with binocular vision, the view through each eye is slightly different, which adds to the illusion of three dimensions. When viewed with one eye, the visible image changes as the observer moves, which approximates the view of a real three-dimensional object.

The views of the cube in FIG. 7 were created using a simple graphics feature in a word processor program (Word 2007). Actual photographs or images using more sophisticated graphics software can produce more realistic images.

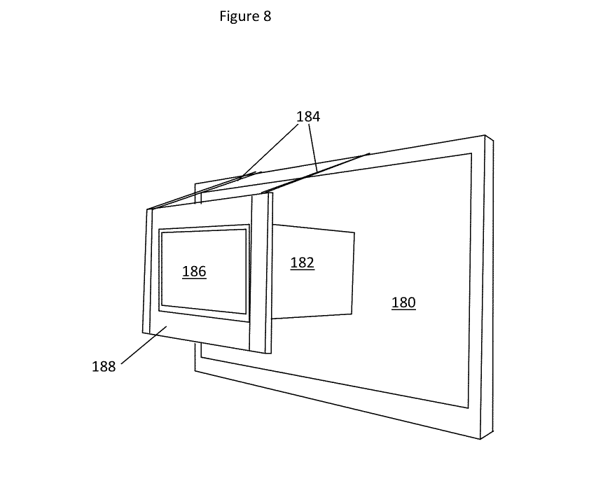

FIG. 8 shows an example prototype assembly for viewing this image. A computer monitor 180 provides an image that is viewable through lenses 186. The lenses and the image are similar to those described earlier for FIGS. 5 and 6. Straps 184, a housing 182 and a clear plastic holder 188 position the lenses relative to the image. The straps may be simply adhesive tape. The housing is foam poster board or similar material. The plastic holder is of the type used to hold photos for office display.

The lenses and monitor used in the prototype in FIG. 8 are standard, commercially available components. Each of the four lenses is about 3 inches wide and 1⅝ inches high. The distance from the image to the lens is about 6 inches, which is close to the focal length of the lens. The lenses are plastic Fresnel lenses about the size of a credit card that are commonly sold as small magnifying glasses. The only significant modifications were trimming the non-grooved borders of the lenses. An example vendor for the lenses is 3dlens.com from Taiwan. The monitor is a typical LCD computer monitor, e-machines brand, model E202EHV dmb. The monitor is capable of displaying at a resolution of 1600×900 pixels with true dimensions of the screen of about 17¼×8¾ inches.

FIGS. 5 through 8 show images and lenses that are approximately rectangular, but other geometries are possible and may give advantages in some cases. For example many commercially available glass or plastic convex lenses are circular, in which case a hexagonal images and partitions are desirable with a lay-out similar to that for a honey comb. Other polygons or more complicated shapes are also possible for both the focusing means and the image means.

Many other geometries are possible. For example the lenses do not have to be parallel to the image surface. It may be desirable to have non-parallel lenses for interior or exterior corners where space constraintly limit the geometry. Also the lens does not need to exactly match the dimensions of the image. The lens may larger or smaller or have different shape. The advantage of the keeping lenses the same size as the corresponding image is in maximizing the field of view and resolution for a flat array; for other shapes it may be desirable to have different geometries. An example of this is the case of a cylindrical array that will be described in later figures.

In addition to Fresnel lenses, biconvex or plano-convex lenses are desirable. The plano-convex lens with the flat side in contact with the image surface is especially desirable for image sizes of a few millimeters or smaller in order to achieve a small focal length and to maintain accurate positioning between the image and the lens.

General commercial production would favor combining multiple lenses into a single sheet of material. This approach eliminates potential fit-up issues and ensures accurate positions of the lenses. Experience shows that the small misalignment between the images and the lenses is not critical so long as the spacing between the lenses agrees with the spacing of the images.

For the most realistic displays for close viewing from a distance of a foot or two, the image sizes should be small (on the order of a few millimeters or less in size) with extremely high pixel density (on the order of 100 to 1000 pixels per millimeter=2500 to 25000 pixels per inch) in contact with a sheet of small plano-convex lenses. Current commercially available displays for computers are much lower, around 100 pixels per inch, although displays with over 2000 pixels per inch are available. Commercial film resolution is about 100 lines per mm=˜2500 lines per inch. The optical limit based on a typical wave length of light is on the order of 500 nanometers, which corresponds to an optical limit of about 2000 pixels per millimeter=50000 pixels per inch.

The above figures are for an image that is located approximately one focal length from the lens. If the lens is located closer to the image, the rays of light from a point on the image diverge after leaving the lens instead being parallel. This creates the illusion that the image is at a finite distance behind the lens. The apparent distance of this image is approximated by the equation for a magnifying lens:

D/L=1/(1−X/L)−1

Where D=apparent distance
L=focal distance
X=actual distance between the lens and the image.

For the cube shown in FIG. 7, the three-dimensional illusion is further enhanced if it is viewed through lenses that are less than one focal length from the image so as to create an apparent distance that is nearer to the observer. Ideally the apparent distance should agree with the different views to produce the illusion of an object that is a fixed distance behind the lenses. For scenes with objects at various distances, the selection of the apparent distance is a compromise to some degree and may vary depending on which parts of the scene are considered most important.

The ability to produce a range of apparent distances with a relatively small change in the distance between the lens and the image allows for the production of a three-dimensional image of great apparent depth in a small space. If the image is a relief or multiple layers, it is possible to produce a three-dimensional image with different apparent distances. Also, in the case of having multiple objects depicted in an image means, their apparent distance may be determined by their placement in the image and their relationship to one another.

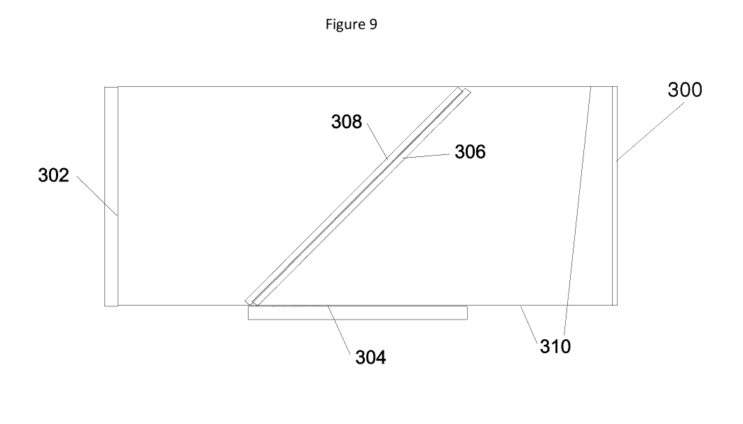

FIG. 9 shows a system that uses multiple layers of displays of varying apparent distance to create the illusion of depth. A background layer is a conventional video display 302. The foreground layer is partially silvered mirror 306 that reflects light from a second display 304. A liquid crystal film 308 selectively block light from the background layer wherever the foreground layer is active, which gives the illusion of an opaque foreground. A lens 300 amplifies the differences in actual distance to produce a three-dimensional image of much greater depth. This distance from the lens to the background layer is normally less than or equal to the focal length of the lens. As with the earlier the configurations, the setup in FIG. 9 may be simply one element of an array of similar elements.

This setup has the benefit of having layers of the image means that change in size and in relation to the background at different rates when viewed from multiple angles and distances by the viewer, giving a greater sense of realism as the image means located closer to the focusing means show greater change than those in the farther one. This setup could also implement multiple layers of image means with respective elements of partially silvered mirror and liquid crystal to have more elements that change at different rates when viewed at different angles and distances.

The same effect could also be achieved through the use of transparencies with the closer elements applied in an opaque ink, paint, or cutouts, although it may be difficult to avoid glossiness of the transparency from being visible. Also a cutout could be used on its own provided that it could be stood or suspended parallel to the focusing means.

Cylindrical Configuration

It is frequently desirable to have something other than a flat array. For example, a cylindrical or spherical array allows the creation of a three-dimensional image that can be viewed from a wider range of angles than is possible with single flat array. The image is then similar to that of a real object in a display case. While on the surface this feature should greatly complicate the geometry of the imaging system, a surprising result is that essentially the same imaging elements can be used for not-flat and flat arrays.

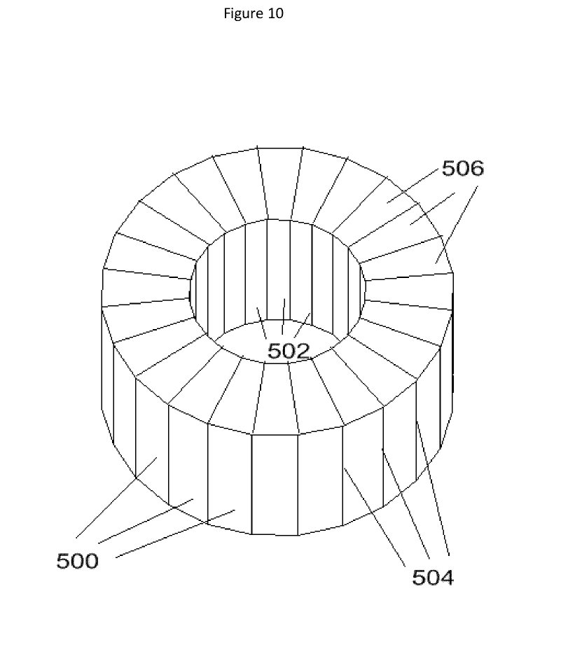

FIG. 10 shows an example of a cylindrical array that is suitable for viewing from the outside. Image means 502 are located in the interior and the focus means 500 is located around the perimeter. The focus means are preferably Fresnel lenses of essentially the same geometry.

The distance between the images and the lenses is preferably less than the focal length of the lens at a value that gives an apparent distance that corresponds to that of an object located near the center of the cylinder. For example, a lens located at one focal length from the center of the cylinder and an image located at half a focal length would correspond to an apparent location near the center of the cylinder as calculated in the equation.

The image may be single transparency or piece of paper that is folded so that each section is approximately parallel to the corresponding lens. Partitions 504 separate the images so that only one image means is visible from the each lens. The partitions are preferably opaque or translucent and should not have a glossy or reflective surface that may confuse the viewer. A housing 506 holds the lens and image means in an approximately fixed relative position and also prevent viewing of the image means without a lens.

The basic idea is that each lens sees a separate image from a different angle. One way to produce these images would be remove the image means and the lens and locate an object at the center of the cylinder. A camera could then record images from locations corresponding to the center of each lens. These images then can be printed onto a transparency or piece of paper to create the image means. Other options for image means include multiple monitors, flexible film display, projector to a screen, or other display that would provide an illuminated image. For image means located closer than the focal length of the lens in may be preferable to take images from a wider angle.

While this figure shows a case with a single row of lenses around the perimeter of the cylinder, it is normally desirable to have multiple rows of lenses, each with a corresponding image. This approach can create the illusion of a real object near the center of the cylinder with the visible image corresponding to the viewing angle in both the horizontal and vertical directions.

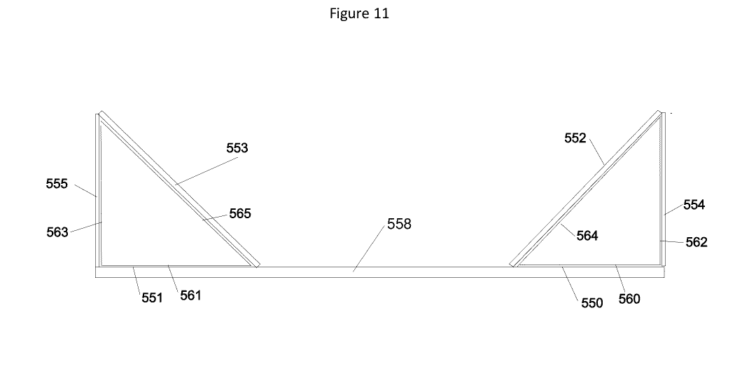

FIG. 11 shows an example of using mirrors in combination with a flat display in a cylindrical configuration. Images 550 and 551 in a display 558 reflect from mirrors 552 and 553 through lenses 554 and 555 respectively. The angle between the surface of the mirror and the surface of the display is about 45 degrees so that light rays travel about an equal distance in travelling from the display to the lens.

Optional polarizing filters 560, 562, and 564 prevent direct viewing of the image through the lens. Filters 560 and 562 are oriented with planes of polarization at approximately right angles so that light leaving the image is blocked from passing directly through the lens. The plane of polarization of filter 564 is approximately 45 degrees from that of the other two filters so that light that reflects from the mirror 552 is visible through lens 554.

FIG. 11 shows just two elements. The elements may be arranged to form a cylinder similar to that of FIG. 10. The cylinders may be stacked to produce a cylinder display of any desired size. One possibility is to invert the elements of for a cylinder on top so that there is no issue with the thickness of the display used to produce the images. This arrangement allows for two rows of lenses without any vertical separation. Another option is to use thin-film displays. For any of these examples is the display may produce moving images to give the illusion of a moving three-dimensional object.

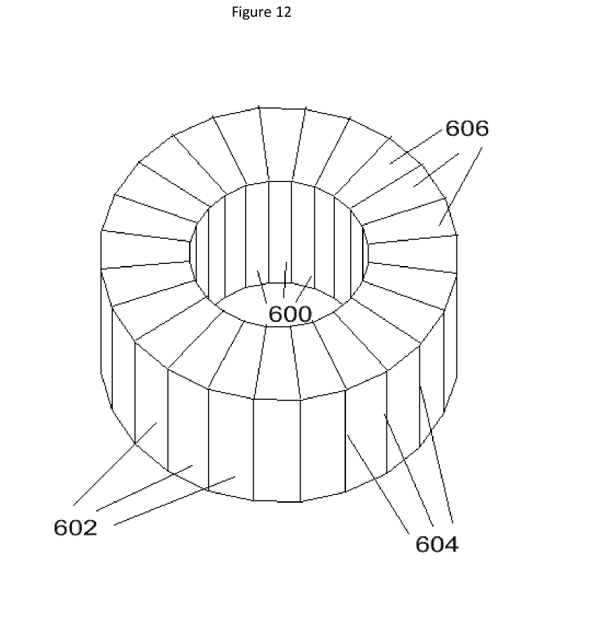

FIG. 12 shows an example of a cylindrical array that is suitable for viewing from the inside. This set-up is similar to that shown in FIG. 10 but with two important differences. First the location of the images and the lenses are reversed, which means that the lenses 600 are in the interior and the image means 602 are around the perimeter. Second the distances between the image means 602 and the lenses 600 are close to the focal length of the lenses. Optional partitions 604 are found between adjacent image means. This configuration creates panoramic view around the full circumference of cylinder of objects at a far distance from the center of the cylinder. This configuration could also used a setup similar that shown in FIG. 9 to provide a realistic change in images located closer to or further from the focusing means.

Many variations of these basic configurations are possible. The mirror set-up from FIG. 11 may be combined with the configuration in FIG. 12 to allow a single flat screen to produce the illusion of a 360-degree panorama. The arrays may approximate practically any shape such as inside or outside of spheres, curved surfaces, polygons, etc.

Systems using Mirrors as Part of the Focusing Means

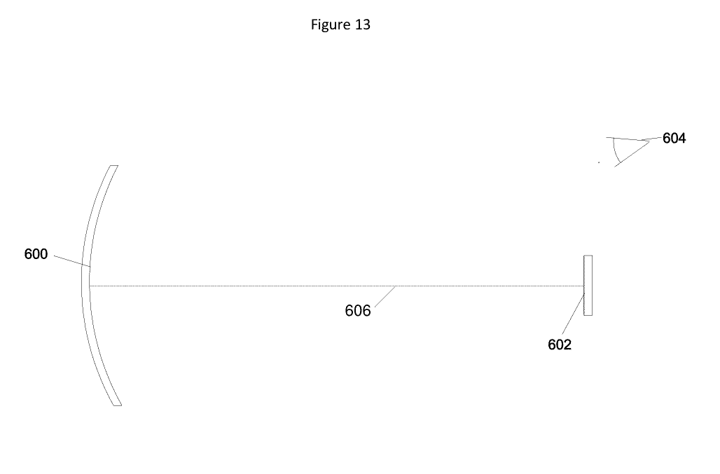

The system can also work in a system with a mirror instead of a lens as the focusing means. FIG. 13 a display element with a concave mirror 600. An image means 602 is located near or inside the focal point of the mirror and is preferably located on a common centerline with the mirror 606. An observer 604 would see an image that appears to be behind the mirror 600. As with the earlier lens configurations, it is desirable to use an array of display elements to create a composite three-dimensional image.

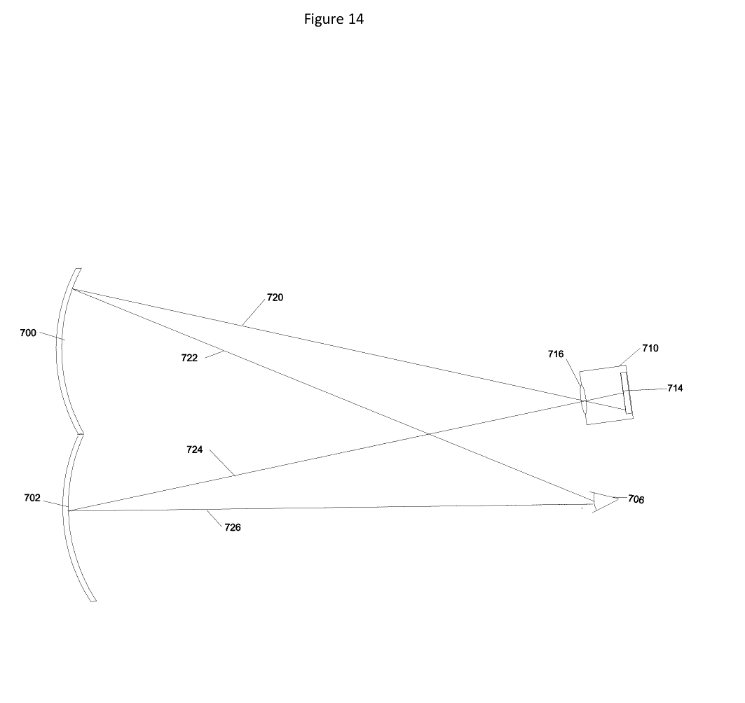

FIG. 14 shows an embodiment that uses a projector as part of the display. Curved mirrors 700 and 702 in combination with the optics 716 in the projector 710 serve as the focusing means. The image means 714 is the slide, motion picture film, transparency, digital micromirror device, etc. that is normally part of the projector.

As shown in FIG. 14, the curved mirrors are located on a large concave surface 730, which adjusts the angle of each mirror with respect to the projector for optimum viewing. The projector focuses multiple two-dimensional images onto a surface of focus, which is where an image would be in focus for a conventional screen. Each image corresponds to one of the curved mirrors.

The mirrors have a focal distance that is normally much smaller than the distance to the projector. For optimum viewing realism, the curve of the mirror should correspond to the viewing angle of the image. While FIG. 14 shows concave mirrors, convex mirrors would also work. In the case of a convex mirror the images would need to be inverted compared to keep the same orientation for the observer. As with the concave mirrors, light rays should reflect from the edge of the image in the mirror at an angle that agrees with the field of view of the image. This geometry gives a similar focal distance to that for the concave case, except that the sign is reversed for a convex mirror (focal point behind the mirror instead of in front).

The above system requires careful alignment to create a realistic three-dimensional image. The focal point of the concave surface approximately coincides with the focal point of the projector optics. The center of each image should project onto the center of each mirror.

The system in FIG. 14 would normally need many more elements to produce the same image quality as those from the early figures. The difference is that observer would normally see only a narrow but intense beam of light from each curved mirror. The rest of the light hitting the mirror is reflected away from the observer. This characteristic favors the use many mirrors in order to produce a realistic image. This feature should be true for both concave and convex mirrors.

The above system may also serve as a holographic recording device if the projector is replaced by a camera. The resulting photograph or digital image may then be projected to recreate a holographic image.

Configurations for Recording and/or Transmitting Holographic Images.

The above embodiments assume that images are available for use in the holographic display system. In many cases the images may be produced using a computer. For the case of an image of a distant object, single photograph or multiple copies of the same photograph may serve as the image means. However, it is also desirable to be able to record holographic images.

Holographic Recording Systems

As mention earlier an array of cameras can produce a holographic record. The basic idea is that the lens for each camera should be at a location that corresponds to the center of each focusing means in the displays described above. What is important is to approximate the same relative position of each camera, which means that the ratio of distances between cameras is the same compared to the distance to the object. A pinhole or a mirror may also be used instead of a conventional camera lens.

For the case of lenses as the focusing means, the procedure would start by creating a scale model of the display assembly preferably including the partitions, but without the image means and lenses used in the display elements. The cameras would be located where the center of each lens had been and would directed toward the where the center of each corresponding image had been. The assembly with the cameras is then directed toward the object to be recorded. The partitions would effectively crop each image to match the dimensions and viewing angle required for each display element. If the partitions are not used then it may be necessary to restrict the field of view of each camera or to crop the resulting images to match the viewing angles for each image in the display. Depending on the images means distance from the focusing means in relation to the focal length of the focusing means, it may be necessary to use images from a wider or more narrow angle.

Alternatively a single camera may be used and simply moved relative to the viewed object to record images from different viewing angles. Another alternative is to use mirrors or diverging lenses to produce multiple images of the same object from different viewing angles that may be recorded in a single photograph.

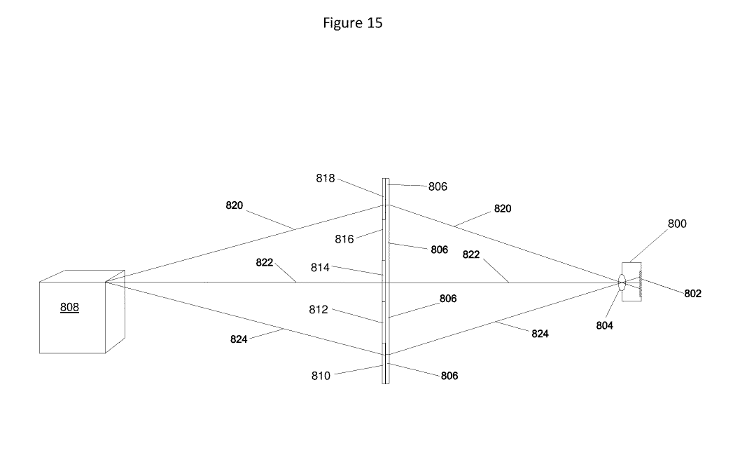

FIG. 15 shows an example system for using a single camera to record multiple images from different angles. A camera 800 comprising a lens 804 and an image recording device 802 views an object 806 through a converging lens 806 and diverging lenses 810, 812, 814, 816, and 818. The converging lens 806 is preferably a Fresnel lens. The diverging lenses 810, 812, 814, 816, and 818 are preferably Fresnel lenses that form a single sheet with essentially the same dimensions and focal length. The lens 804 of the camera 800 is near the focal point of the converging lens 806. The focal length of the diverging lenses is preferably shorter than that of the converging lens 806.

This geometry results in multiple virtual images of the object 808 that are visible from the camera 800. To illustrate how this works consider three light rays 820, 822, and 824. The first ray 820 passes from a point on the object 808 through a lower point on the diverging lens 818 that results in light exiting the lens horizontally as it enters near the top of the converging lens 806. Since the camera's lens 804 is at the focal point of the converging lens 806, the light ray then exits converging lens at an angle that causes it to pass through the camera's lens 804 to a point on the recording device 802.

The second ray 822 starts at the same point on the object 808 and passes through the middle of diverging lens 814 and the converging lens 806 to the camera lens 804 to the middle of the recording device 802.

The third light ray 824 starts at the same point on the object 808, passes through an upper part of diverging lens 810, enters the converging lens 806 horizontally which directs it through the camera's lens 804 to an upper part of the recording device 802. The result is that the camera simultaneously records multiple images of the object as viewed from different locations.

The resulting images may be cropped to match the viewing angles required for the image means. Alternatively, partitions may be included between the diverging lenses and the object to restrict the field of view as required, although cropping may be necessary to avoid the appearance of the partitions in the images. While FIG. 15 shows five diverging lens in a line, it would be desirable to use two-dimensional array of lenses on a single sheet.

If a projector replaces a camera, the embodiment of FIG. 15 may also work in reverse to project a three-dimensional image in a manner similar to that shown in FIG. 14. Ideally there would need to be large array of diverging lenses in order to achieve a good image resolution.

Virtual Media

For virtual media, such as 3-D animation, it is possible to create accurate images to be used as the image means for any type of display listed above. The image can be taken using virtual cameras and moving them to locations that correspond to the center the focusing means.

For the case of lenses as the focusing means, the procedure would start by creating a virtual scale model of the display assembly preferably including the partitions, but without the image means and lenses used in the display elements. The virtual cameras would be located where the center of each lens had been and would be directed toward the where the center of each corresponding image had been. Alternatively, the render size may be set to the size of the resultant image means. The assembly with the cameras is then directed toward the object to be recorded. The partitions would effectively crop each image to match the dimensions and viewing angle required for each display element, or render setting can be used when acquiring the images for the same results. If the partitions or exact render setting are not used then it may be necessary to restrict the field of view of each camera or to crop the resulting images to match the viewing angles for each image in the display. For images taken intended to be less than one focal length away from the camera, a wider angle may be necessary.

Alternatively it is possible to use a single virtual camera and move it to multiple locations. The same ideas apply for rendering multiple frames as part of an animation. For maximum realism, the distance between cameras and the virtual object should approximately equal to the apparent distance of the object from the focusing means in the display. If convenient, distances may be scaled by a fixed factor.

While not preferred, it is also possible to produce virtual images manually using conventional techniques of perspective drawing. This approach requires producing multiple images of an object close to those of the layouts described above.

Transmitting Images

The system allows a great improvement in the ability to transmit three-dimensional information electronically. For example cameras can record images and transmit the information over the internet, cable, fiber optics, microwave, radio, television, telephone, or other electronic or optical communication systems. The observer may then view the images at a remote location. Communication in this manner can be bi-directional or multi-directional which allows for its use in conversations, conference calls, and virtual meetings, etc. Data compression systems such as those found in the prior art may be especially useful to reduce bandwidth requirements for transmitting images.

Displays with Other than Visible Light

While the above descriptions are mainly directed toward displays with visible light, the same principles can apply to non-visible electromagnetic radiation, sound waves, particle beams, and other applications that allow for emission and focusing of beams

Advantages

The new display system described here has many advantages compared to display systems found in the prior art. Compared to conventional holograms, it has large advantages in the ease of producing images since it does not rely on wave interference patterns that are difficult to produce and to record. It can easily record or transmit moving and color images for displaying realistic three-dimensional images using conventional photographic and optical components or with virtual media using commercially available software. It can display the images using commercially available optics and a wide range of conventional image components such as electronic displays, photographs, slides, and transparencies, while true holograms requires special film using monochromatic laser light. It is able to do all this while producing true three-dimensional images that have a comparable level of realism that has been unique to holograms.

Compared to conventional lenticular systems or systems that require the use of polarizing or colored glasses to provide separate image to each eye, the new display system provides a much greater degree of realism and versatility. A key advantage is that the system does not require observers to keep their eyes level with a screen. In addition, the observer can move around the display and view the image from different angles and distances while maintaining a realistic illusion of a three-dimensional image.

1. A holographic display element comprising:
image means for producing a real two-dimensional image and
focusing means for directing light from a location on said two-dimensional image to produce a family of light rays that appear to emanate from a point that is noncoincident with the image surface.

2. A holographic display element of claim 1 wherein said focusing means is a lens.

3. A holographic display element of claim 2 wherein said two-dimensional image represents a view of a three-dimensional object as viewed from the center of the lens.

4. A holographic display element of claim 1 wherein said focusing means comprises a curved mirror.

5. A holographic display element of claim 4 wherein said curved mirror comprises a convex mirror.

6. A holographic display element of claim 4 wherein said curved mirror comprises a concave mirror.

7. A holographic display system for creating the illusion of a three-dimensional object comprising:
a first element that comprises a first image means that represents a first view of the object and a first focusing means and
a second element that comprises a second image means that represents a second view of the object and a second focusing means wherein light emanating from a first point on the first image is focused by the first focusing means create first light rays and light emanating from a point on the second image means that corresponds to the same apparent location on the object is focused by the second focusing means to produce second light rays so that the first and second light rays appear to emanate from a common point.

8. The holographic display system of claim 7 further comprising additional elements to form an array so that light corresponding to the same location on the object appears to emanate from a common point shared by multiple display elements.

9. The holographic display system of claim 8 wherein the images for said elements are on a common plane.

10. The holographic display system of claim 8 wherein the images for the holographic display are noncoplanar.

11. The holographic display system of claim 8 wherein the images are on curved surfaces.

12. A method for producing holographic images comprising
producing an array of two-dimensional images that represent views from different locations of three-dimensional object and
transmitting light from the array of images to through an array of focusing means so that the light from multiple two-dimensional images form a three-dimensional image.

13. The method of claim 12 wherein producing said array of two-dimensional images comprises displaying the array of images on an electronic display.

14. The method of claim 12 wherein producing the array of two-dimensional images further comprises photographically recording an array of images and displaying the resulting images.

15. The method of claim 14 wherein photographically recording is digital recording.

16. The method of claim 15 further comprising electronically transmitting the digital recording for display at a remote location.

17. The method of claim 12 wherein producing an array of two-dimensional images comprises developing a virtual representation of a three-dimensional object and displaying an array of images of that represent different views of said virtual three-dimensional object.
